(19) United States
(12) Patent Application Publication
(10) Pub. No.: US 2026/0054264 A1
(43) Pub. Date: Feb. 26, 2026

(54) PORTABLE TESTING DEVICE WITH MODULAR POD UNITS FOR SAMPLE TESTING

(71) Applicant: Agdia , Inc., Elkhart, IN (US)

(72) Inventors: Albert Vrient, Elkhart, IN (US); Keith Schuetz, Elkhart, IN (US); Coilin Walsh, Elkhart, IN (US)

(21) Appl. No.: 19/309,488

(22) Filed: Aug. 25, 2025

Related U.S. Application Data
(60) Provisional application No. 63/686,642, filed on Aug. 23, 2024.

(51) Int. Cl. B01L 3/00

(52) U.S. Cl. CPC B01L 3/5085; B01L 2200/028; B01L 2200/087; B01L 2300/021; B01L 2300/023; B01L 2300/027; B01L 2300/0654; B01L 2300/0663

(57) ABSTRACT

A portable testing device that includes a head unit with a user interface and modular pod units that are attachable to the head unit and include componentry for performing assay testing of biological samples received in each respective pod unit. The head unit can utilize a user interface and optical reader of a modified tablet device incorporated within the housing of the head unit. The pod units can utilize a well block for receiving an array of sample tubes and an optical assembly having LEDS, a multiple bandpass filters, and a single ADC board with photodiodes that are disposed on both sides or only on one side of the receptacle of the well block.

### CROSS-REFERENCE TO RELATED APPLICATIONS

This application is a Non-Provisional of and claims the benefit of priority of U.S. Provisional Application No. 63/686,642 filed Aug. 23, 2024, the entire contents of which are incorporated herein by reference in its entirety.

This application is generally related to the following co-owned applications: U.S. Pat. No. 10,036,058 issued Jul. 31, 2018; U.S. Pat. No. 10,731,207 issued Aug. 4, 2020; U.S. Pat. No. 10,371,636 issued Aug. 6, 2019; and U.S. Pat. No. 10,775,306 issued Sep. 15, 2020, each of which is incorporated by reference in its entirety for all purposes.

### BACKGROUND

The present invention relates to devices that are capable of analyzing biological samples, and in particular, to a modular testing device for analyzing biological samples.

Biological samples are typically tested in laboratories after the biological samples are collected in the field. A number of steps are taken to prepare the sample after it has been collected, including mixing the sample with reaction buffers, dyes, and any other chemical solutions needed to prepare the sample for testing. During or after sample preparation, testing equipment also needs to be prepared. This can include warming up the equipment, calibrating the equipment for the specific tests to be run, and running through any other initial procedures required for the specific testing equipment being used. Once the sample and the equipment are prepared, the prepared sample can be placed in the equipment for testing.

The typical process for testing biological samples described above has significant disadvantages. One disadvantage is that biological samples need to be collected in the field, brought into the laboratory, and then tested. This can present the following issues. First, the biological sample can be contaminated between the time when it was collected and time that it is to be tested. Second, it can be discovered that not enough biological sample was collected in the field, preventing the testing from being complete. Third, it can be later discovered that the biological samples that were taken are otherwise unsuitable for testing. Fourth, biological samples can have various degrees of stability and some can begin degrading at time of sampling effecting the outcome of a correct diagnosis. When a biological sample is unsuitable for testing for any of the above reasons, an additional biological sample will need to be collected in order to complete the testing, which requires additional time, money, and other resources.

To eliminate the problems discussed above, portable testing devices have been developed for analyzing biological samples in the field. One such device is disclosed in PCT Application No. PCT/US2014/59487, filed on Oct. 7, 2014, and entitled “Portable Testing Device For Analyzing Biological Samples,” the entire disclosure of which is incorporated by reference for all purposes. In order to be portable, the testing device needs to be small enough so it can be easily transported. This limitation on the size of portable testing devices limits the number of biological samples that can be tested at one time. While these aspects are described with regard to biological samples, it is appreciated that these aspects also hold true for collection and testing of various other types of samples, such as samples collected for detection of heavy metals, chemical, toxins or other compounds, for example, fluorometric methods for detection of contaminates.

Another challenge associated with such devices is that certain components, in particular the processing units and user interface features, can quickly become obsolete or sub-optimal due to rapid developments of these components and consumer electronics. Therefore, there is a need for testing devices that are more user friendly and more readily updatable and that can be more easily manufactured and assembled.

### BRIEF SUMMARY

In one aspect, the invention pertains to a portable testing device that includes a head unit having a user interface and a central processor and componentry and further includes one or more pod units removably coupled to the head unit, each pod unit having assay processing componentry that perform assay processing and testing of one or biological samples disposed in the respective pod unit. The head unit can be operably coupled with one pod unit, or multiple pod units (e.g. 2-10 pod units, typically 2-4 pod units) connected serially. The pod units can be identical or can be of differing types or designs. In one embodiment, in addition to physically coupling one or more pods, multiple attached pods can simultaneously run different or similar protocols. For example, Pod A could run FAM/HEX assay for 15 minutes at 39° C., while Pod B runs a HEX/ROX assay for 30 minutes and 42° C., while Pods C and D run a FAM/ROX 20 minute 40° C. protocol with melt back analysis. Alternatively, all the connected pod units could run the same protocol at the same or differing times. It is appreciated that these protocols are exemplary and that these or other protocols could be utilized. Advantageously, the design described herein provides the ability to scale the processing ability of the device as the user's needs grow and the ability to run different protocols on the same device at the same time that differentiate the device from conventional devices used in the field.

In another aspect, the head unit includes user interfaces features of a modified tablet that has been incorporated within the housing of the head unit. The modified tablet can be a portable tablet device having a touchscreen interface and a front facing camera. In some embodiments, the head unit includes a housing that encloses and protects the internal componentry of the head unit. In some embodiments, the modified tablet is permanently attached and incorporated within the housing of the device such that it is no longer removable for use as a mobile tablet by an end user. In some embodiments, the tablet has been modified by removal of the battery that allows for its use a portable device by itself, and a heat sink has been attached to a rear side of the tablet to facilitate heat dissipation during operation while confined within the housing cavity. In some embodiments, a power cord remains attached to support a power cord that couples the tablet to the power source of the head unit. It is advantageous to design the portable device in a manner that incorporates state of the art consumer electronics components, such as a tablet device, as this improves the ease of use and operation of the device and improves the ease and speed of manufacturing and assembly of the portable testing device and overcomes user experience and user interface challenges associated with conventional devices.

In some embodiments, the tablet is incorporated within the housing by confining the tablet between a main body and a bezel of the housing. The housing of the device includes the main body housing and the bezel, which includes a frame and cover. The bezel is secured to the main body by one or more fasteners (e.g. screws, torx screws). The fasteners can be configured to be non-removal by an end user. The bezel includes a main opening through which the user can access the touchscreen of the tablet.

In some embodiments, the tablet has been modified for use within the portable testing device in manner that renders the tablet unsuitable for use as a portable personal device. First, the battery that allows for portable use of the tablet has been removed. The tablet must then be connected by a hardwire cable to a power source of the portable testing device. Second, since the tablet is being incorporated into the confines of the outer housing of the head unit, it may be prone to overheating during extended use. Accordingly, a heat sink can be attached to rear side of the tablet to dissipate heat generated during use and prevent overheating. In some embodiments, the tablet has attached to a rear side a heat sink assembly that further includes a support for the power cable to ensure that the power cord remains securely attached. In some embodiments, the device further includes a fan to provide cooling air flow into the housing cavity.

In some embodiments, the portable testing device head unit utilizes a front-facing camera of the tablet to read an identifier to obtain information pertaining to parameters of the assay being performed, the sample, and/or the patient. In some embodiments, the tablet includes thereon a specialized software application that operates the tablet and camera in order to obtain the information by reading an identifier (e.g. barcode, QR code) with the front-facing camera. In some embodiments, the bezel includes another opening through which the front-facing camera can image the identifier. In some embodiments, the bezel includes a small magnifying lens within this opening so as to increase magnification of the front-facing camera so that the camera can read the identifier more easily. In some embodiments, the device includes a reader that detects RFID/NFC from which the test parameter info is obtained.

In still another aspect, each pod unit includes a receptable where one or more sample tubes are placed for assay processing. The receptacle can be a recess or can further include a plate or card with multiple openings to receive a tube array. The pod unit includes therein a well/heating block that can accommodate one or more sets of LED or photodiodes and one or more sets of emission/excitation (EM/EX) filters. In some embodiments, the well/heating block includes LEDs and filters on only one side. In such embodiments, on a single side, the pod unit includes one LED board: one EX filter: one EM filter; and one ADC board consisting of the photodiodes and respective processing chips. In some embodiments, the LED board includes three specific LEDs: the EX filter includes three specific bandpass wavelengths; and the EM filter is configured for three specific wavelengths. In some embodiments, “one” as set forth above can be understood to mean “one and only one” for each respective pod unit. In other embodiments, the pod unit includes a set of LEDS, an EX filter and EM filter on each side of the recess that receives the array of sample tubes.

### BRIEF DESCRIPTION OF THE DRAWINGS

FIG. 1 a front perspective view of a head unit of a portable testing device in accordance with some embodiments.

FIG. 2 a rear perspective view of a head unit of a portable testing device in accordance with some embodiments.

FIG. 3 a cross-sectional side view of a head unit of a portable testing device in accordance with some embodiments.

FIG. 4 a pod unit of a portable testing device in accordance with some embodiments.

FIG. 5 is a view of the opposite side of the pod unit of the portable testing device of FIG. 4 in accordance with some embodiments.

FIG. 6 is a portable testing device that includes a head unit coupled with two pod units in accordance with some embodiments.

FIG. 7 is another view of the portable testing device that includes a head unit coupled with two pod units in accordance with some embodiments.

FIG. 8 is a cross-sectional side view of the portable testing device that includes a head unit coupled with two pod units that show the electrical connections and optical assemblies in each pod unit, in accordance with some embodiments.

FIG. 9 is another cross-sectional side view of the portable testing device that includes a head unit coupled with two pod units that show the coupling/lock connections between the head unit and pod units, in accordance with some embodiments.

FIGS. 10A-10B are detail views of the coupling/lock interface between a head and pod unit of the portable testing device in accordance with some embodiments.

FIG. 11 is a rear cover for coupling to the last connected pod unit or battery of the portable testing device in accordance with some embodiments.

FIG. 12 is a tablet that has been modified to be incorporated within the housing of the portable testing device in accordance with some embodiments.

FIG. 13 is another view of the modified tablet in accordance with some embodiments.

FIG. 14 is a cross-sectional side view of the sample well/heating block of a pod unit in accordance with some embodiments.

FIG. 15 is a perspective view of the sample well/heating block of the pod unit in accordance with some embodiments.

FIG. 16 is an exploded view of the sample well/heating block of the pod unit in accordance with some embodiments.

FIG. 17 is an exploded view of the sample well and the LED, image detectors and filters within the pod unit in accordance with some embodiments.

FIGS. 18A-18D shows a configuration of the portable testing device that includes a head unit coupled with four pod units in accordance with some embodiments.

FIGS. 19A-19J show various views of the head unit housing including details of the bezel and tab connection components and internal fan in accordance with some embodiments.

FIGS. 20A-20B shows a battery pack that attaches to a rear pod unit for extended portable use in accordance with some embodiments.

### DETAILED DESCRIPTION

In general, the present disclosure relates to modular portable testing devices for analyzing biological samples. In the embodiments described below, the modular testing device is capable of testing biological samples with an isothermal amplification process, such as NEAR chemistry, LAMP chemistry, RPA chemistry, or NASBA chemistry. This eliminates the need for thermocycling as a means to amplify nucleic acid products for endpoint detection.

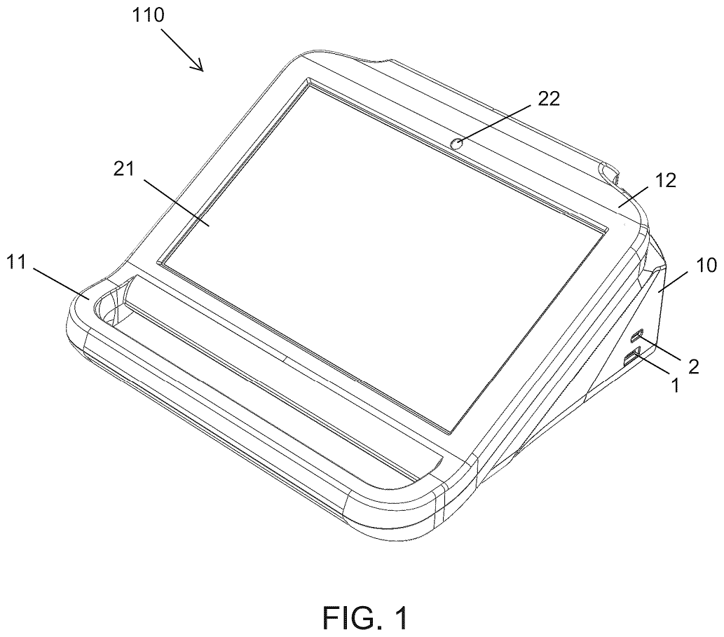

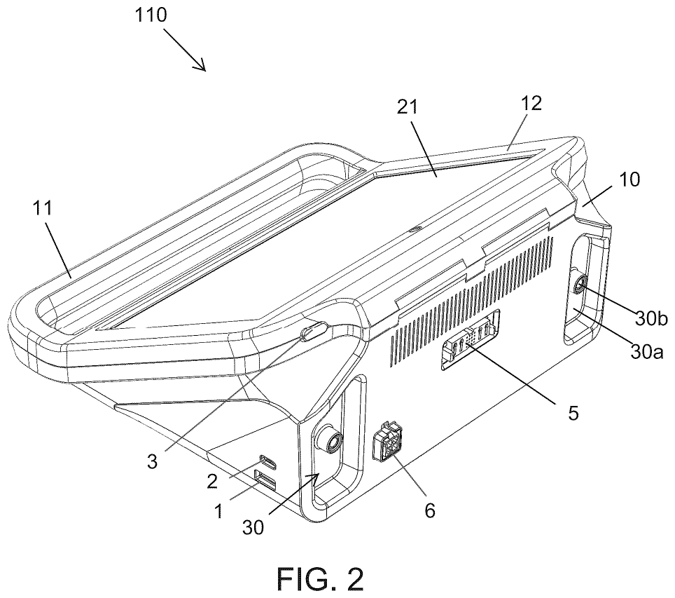

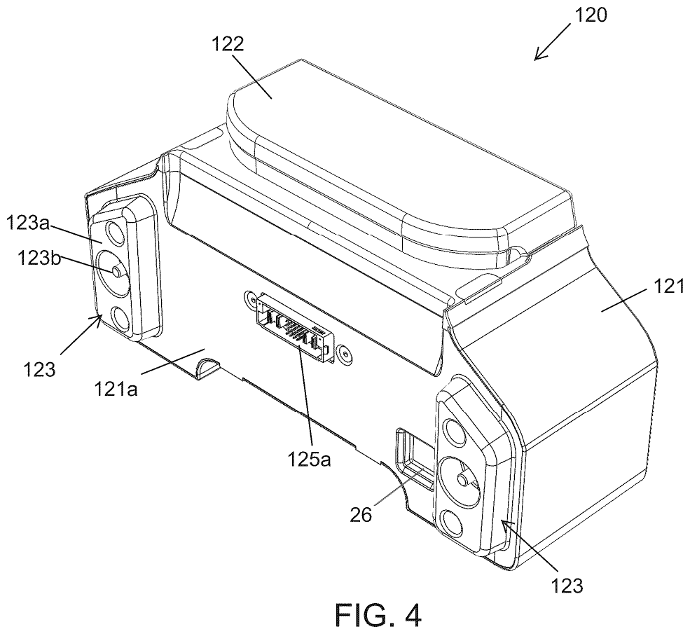

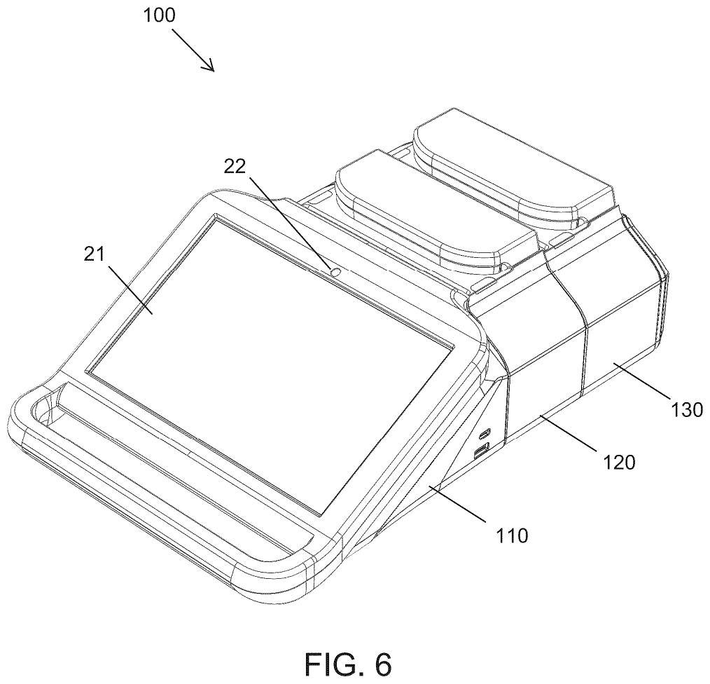

FIGS. 1-2 show a head unit 110 which is configured to couple to one or more pod units to define a modular portable testing device 100, as shown in FIG. 6. FIG. 1 shows a front perspective view and FIG. 2 shows a rear perspective view. The portable testing device can be used to analyze biological samples that have been mixed with a reaction mixture (also referred to as a biological sample and reagent mixture) that are input into the one or more pod units, such as that shown in FIG. 4. Head unit 110 includes a user interface, which is a touchscreen display that allows a user to select parameters for the test protocol, initiate and control assay processing, and which can display data as it is collected. Head unit 110 also includes a central processor unit that controls operation of the assay processing components in the one or more pod units attached thereto. As shown, head unit 110 includes an outer housing that includes a housing main body 10 and a bezel 12 that fits atop and circumscribes the user-interface touchscreen. The housing main body 10 can also include a handle 11 so that the device (head unit and any pod units and/or battery pack coupled thereto) can be easily transported in the field. The handle can be integrated with the head unit housing (e.g. bezel portion or main portion of housing) or can be a separately formed component attached to the head unit. In this unit, the bezel is defined by two components, a frame and cover, which together define the handle. Head unit includes various connectors, such as USB port 1 and USB-C port 2, for connecting one or more peripherals, such as a keyboard or mouse. Power button 3 on the rear facing side of the bezel is used to turn portable testing device 100 on and off. Power jack 6 on the rear side is used to connect portable testing device 100 to a power source (for powering or recharging the head unit) or to connect to corresponding power connector of an adjacent module (e.g. pod unit, battery pack). Connection port 5 connects with a corresponding communication connectors of an attached pod unit to facilitate any of: powering, communication and control of the pod unit by the head unit.

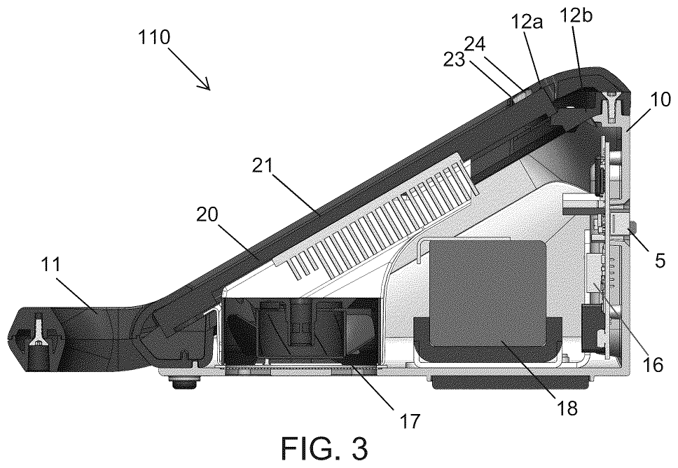

FIG. 3 shows a cross-sectional side view of head unit 110, illustrating the internal components within the housing formed by main body housing 10 and bezel 12. Bezel 12 includes a full-perimeter frame 12b attached to the main housing body and a cover 12a attached to the frame. The tablet rests on the bezel frame 12b and the bezel cover 12a fits over the tablet and attaches to the frame by a tab-connection assembly, thereby securing the tablet in place. The rear side of the housing 10 includes coupling/lock mechanisms 30 on each side for attaching the pod units, and connector 5 extending from the main board for electrically coupling with the pod units for powering and communication with the pod units by the head unit. The internal components of the head unit include a central processing unit 16, which includes a processor and a readable memory having instructions recorded thereon for controlling the pod units and a rechargeable battery 18. The user-interface screen is defined by a tablet device 20 that is integrated within the housing, the tablet 20 resting on internal tabs and confined within the housing by bezel cover 12a that fits over the tablet 20. The bezel 12 includes a main opening through which the touchscreen 21 of the tablet can be accessed by the user for operation of testing device and a small opening 23 over the forward-facing camera of the tablet. In some embodiments, the bezel cover includes a small magnification lens 24 over the small opening 23 to increase magnification of the camera. The bezel 12 and main body housing 10 can be held together by one or more fasteners. In this embodiment, the fasteners are not readily removable by an end user such that the tablet is not removable. In the exemplary embodiment shown, the modified tablet is sandwiched between the housing components of the main body and the bezel which is secured by molded tabs, internal tabs, and torx style security screws. The fasteners (e.g. torx style screws) are exceedingly small and angled such that one attempting to remove the tablet would probably end up destroying the bezel. The holes are very tiny holes, barely the diameter of a paper clip, and are angled such that a suitable tool must be inserted at a proper angle to dislodge the internal tabs to remove the bezel. The tablet is modified by removal of the battery and addition of a heat sink, which is discussed in further detail below. The head unit can further include a fan 17 configured to draw air through a filtered vent and into the internal cavity to cool the tablet and the processor unit during operation.

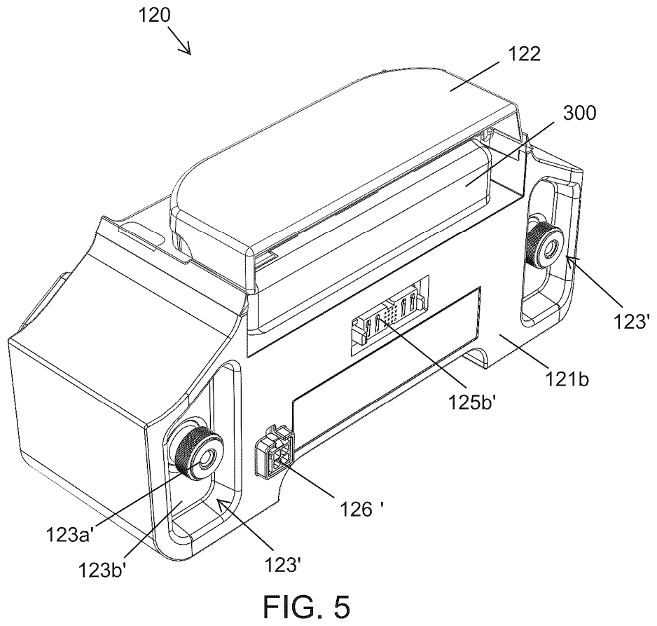

FIGS. 4-5 depict an exemplary pod unit 120 configured for performing assay testing of a biological sample held within, when the pod unit is operably coupled to the head unit either directly or through one or more intervening pod units attached to the head unit in series. In some embodiments, each pod has a set of lights (e.g. RGB LEDs) that are programmed for various light colors and illumination schemes to signal to the operator various run conditions. In some embodiments, these lights are on the horizontal corners just below the rounded lid corners, although it is appreciated that the lights could be disposed elsewhere in other embodiments. As shown in FIG. 4, the pod unit includes an outer housing 121 that encloses the internal componentry and has a top lid 122 that flips open to access the well block for receiving of an array of assay tubes of samples for assay testing. In this embodiment, the top lid contains a spring loaded assembly with heater(s) and thermocouple(s) designed to heat the lids of the reaction PCR tubes to prevent condensation. A front side 121a of the pod unit is configured for attaching and electrically coupling with the head unit. The front side 121a includes coupling/lock mechanism 123 on each end for coupling with corresponding coupling/lock mechanisms of the head unit. The coupling/lock mechanism 123 includes a protruding portion 123a that fits into a corresponding recess in the head unit, and a lock post 123b that fits into a corresponding hole in the head unit. The front side 121a further includes a recess 26, and male electrical connector 125a, which is a multi-pin connector, that electrically couples with the head unit for any of: transmitting power and/or communication from the head unit, through which the head unit controls operation of the pod unit and receives information from the pod unit as to assay testing of the samples.

FIG. 5 shows the rear side 121b of the pod unit, which is configured for attaching and electrically connecting with another pod unit (or alternatively with a rear cover). The rear side 121b of the pod unit similarly includes coupling/lock mechanisms 123′ on each side, which include recesses 123b′ and lock receptacle 123a′, which receive corresponding protruding portions and lock post 123b (same or similar as those shown and described on front side 121a), and a female electrical connector 125b′. This configuration allows the rear side 121b to be attached and electrically connected with a corresponding front side 121a of an identical pod unit. Accordingly, multiple pod units can be connected in a serial fashion, each being independently operable by the head unit through the interfaced electrical connectors. Connector 126 is a power connector that can connect to an AC/DC brick that is plugged into a 110V source. The power and communication is then routed through connectors 125a/125b to the next pod or head unit.

Lid 122 is positioned over the sample receptacle to prevent radiation from escaping housing through the receptacle. As described above, the lid can include a spring loaded heater and thermocouple(s). Lid 122 further prevents ambient light from entering housing through receptacle, which prevents the ambient light from skewing or negating results of the tests that are being run in the pod unit. Lid 122 also covers receptacle to prevent contamination from entering into receptacle when pod unit is being used in the field. Lid 122 is capable of being moved between an open and closed position and can be held in the closed position with any suitable means. In the embodiment shown, lid 120 is held in a closed position with magnets. When lid 122 is in an open position, sample holders (including tube array) can be inserted into and removed from receptacle of the well block. When lid 122 is closed, sample holders will be held in receptacle and radiation in the pod unit will not escape from the housing. When lid 122 is in a closed position, it puts pressure on the sample holder that is placed in a well block in the pod unit, which improves engagement and heat transfer between the sample holder and the heat block in the pod unit.

In one aspect, each pod unit 120 includes the requisite componentry for performing assay testing of the biological samples held within the well block. In this embodiment, the componentry includes a well block assembly that includes a recess for receiving an array of sample tubes, and by which the sample tubes can be thermally cycled by a heater or can be heated and maintained, depending on the applicable protocol. The componentry further includes an optical assembly to amplify, excite, and detect a biological sample that is within the well block. In some embodiments, the pod units can include any of the componentry disclosed in the testing devices described in U.S. Pat. Nos. 10,036,058; 10,731,207; 10,371,636; and 10,775,306, incorporated herein by reference.

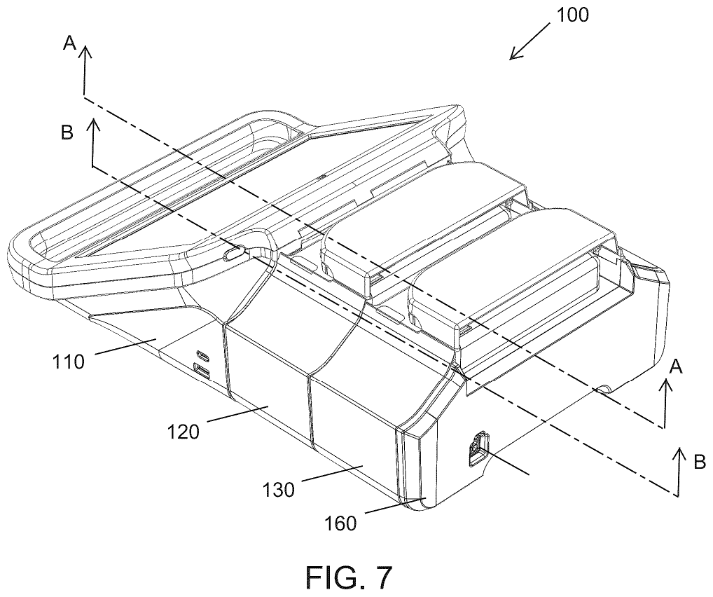

FIGS. 6-7 shows an assembled modular portable testing device 100 that consists of a head unit 110 operably coupled with multiple pod units-two pod units 120, 130.

As shown, the head unit includes a user-interface of a touchscreen display 21 and an optical reader 22, which utilizes the touchscreen display and front-facing camera of a modified tablet incorporated within the housing of the device.

In an exemplary embodiment, only the front-facing camera is used. Preferably, the front-facing camera is used only used to read an identifier (e.g., barcode, QR style code) which provides information to the system as to what test parameters to run (e.g., IE, run time, run temp, and/or diagnostic criteria for determining sample status such as positive, negative, indeterminate, etc.). Alternatively, this information could be entered via the tablet after scanning the barcode. In some embodiments, the reader could be used for loading things like patient ID information via system programming. In some embodiments, an initial scan obtained test parameters and a secondary scan obtains sample and/or patient ID information. In some such embodiments, the tablet camera does not have any function in reading the fluorescence of the assay itself.

In an exemplary embodiment, there are processing units within each of the pod and head units. The pod units have one level of processing where fluorescent light, considered an analog signal, is converted to a digital signal by ADC chips. This information can then be passed along to the head unit for further processing. In some embodiments, the information is transmitted to further downstream chips for further processing before being transmitted to the head unit. The head unit is also responsible for controlling the single or multiple pod variants. In some embodiments, the tablet is used as a human-machine-interface (HMI) and also reports the data to the user in a web-based environment.

As shown in FIG. 7, a rear cover 160 can be coupled to the rear side of the last-connected pod unit 130 to cover the coupling mechanisms and electrical connectors. While two pod units are shown attached here, it is appreciated that the device could include one or more pod units in varying numbers (e.g. 1, 2, 3, 4, 5, 6, 7, 8, 9, 10, etc.), or that the pod unit could be coupled to differing types of pod units having differing capacities or functionality or next generation pod units configured to be compatible with the head unit or prior generation pod units.

Modular testing device is advantageous, as it allows a user to customize its modular testing device for different applications. One or more pod units can be used with a head unit when a user wants to conduct testing in the field. Pod units can be removed or added when a user is conducting testing in a laboratory setting. The pod units allow a user to customize how many tests are run during a testing protocol. In some embodiments, multiple pod units allow for multiple testing conditions to be run at the same time.

Head unit is used to analyze and obtain data from biological samples tested by the pod units. Head unit can also receive information regarding parameters of the assay testing to be performed, information as to the samples to be tested, and/or information as to the patient(s) from which samples are obtained. To accomplish this, head unit is equipped with a user-interface display 21, power supply (which can be a battery or hardwired connection from external power source), and the central processing unit, which enables the head unit to transmit instructions to and receive data from the pod units. The user can also monitor the results of tests that are run on display 21. The processing unit includes hardware, firmware, and software to control the operations of head unit and pod units, including a microprocessor. The head unit can also utilize the processor of the tablet, and can further utilize a specialized software app on the tablet to perform any of the functions described herein. In some embodiments, head unit can utilize wireless capabilities of the modified tablet to communicate with one or more external devices.

A portable testing device having multiple pod units, such as that described above, can conduct testing of a biological sample at the same time or at different times. For example, each pod unit can be loaded with a biological sample. The head unit can then indicate to each pod unit that testing is to begin at the same time. Alternately, a first pod unit can be loaded with a biological sample and the head unit can indicate that the first pod unit is to begin testing. A second pod unit can then be loaded with a biological sample and the head unit can then indicate that the second pod unit is to begin testing. Pod units can test a biological sample using any of: turbidity, fluorescence, chemiluminescence, thermoluminescence, photometric, absorbance, or radiometric means or any combination thereof. Pod units can also run different analytical methods, for example immunoassay, DNA amplification, mass spectrometry, or high-performance liquid chromatography. In some embodiments, the device is configured for DNA/RNA amplification and fluorescent detection. A single head unit can control pod units using different tests and running different analytical methods.

In the embodiment shown in FIGS. 6-7, two pod units are shown. In alternative embodiments, any number of pod units can be used. In this embodiment, each pod unit includes an optical assembly to amplify, excite, and detect a biological sample that is placed in the pod unit for testing. Each pod unit does not have a power supply but is instead powered by the head unit electrically connected to each pod unit through direct or serial connections described herein. Each pod unit further includes an electronic assembly including components that are capable of communicating data to the head unit through the interfaced connections. The head unit communicates with the pod units to indicate what testing is to be run in each respective pod unit, the operating conditions for the run, and when testing is to be initiated. Testing can be completed in each pod unit using the optical assembly and data collected during the testing is communicated to the head unit. In some embodiments, the data can be processed in the pod units before it is communicated to the head unit or it can be communicated to the head unit before being processed. Either way, the data can also be processed in the head unit. In some embodiments, the processed data is displayed on the user interface display. In some embodiments, the processed data is transmitted via hardwired connections. In some embodiments, the processed data is wirelessly communicated by the modified table to one or more external devices or a server.

Optical assembly includes light-emitting diodes and photodetectors to conduct testing of the biological samples placed in the pod units. Typically, the optical assembly further includes excitation and emission filters. Optical assembly can be configured to amplify the biological sample using heat and then excite the biological sample with radiation to detect the presence of a specific fluorescent marker. Biological samples that are placed in the pod units can be mixed with a reaction mixture that contains one or more fluorescent dyes. When the biological sample is placed in the pod units, heat will amplify the biological sample with heat. As the biological sample is amplified it can be analyzed using light-emitting diodes and photodetectors. Light-emitting diodes transmit radiation to the biological sample to excite the target fluorescent markers of the amplified biological sample A plurality of light-emitting diodes can be used in the pod units to excite the biological sample at a predetermined cycle rate. In the embodiment shown, the plurality of light-emitting diodes 142 cycle on and off at 1.54 kHz. It is appreciated these frequencies are exemplary and that various other frequencies could be used. In alternate embodiments, light-emitting diodes can cycle at any predetermined cycle rate. When the biological sample is excited, it will emit radiation and the corresponding wavelengths of the fluorescent dyes that were added to the biological sample. This radiation can be received by photodetectors. A plurality of photodetectors can be used in the pod units to read the emitted radiation from the biological sample at different radiation wavelengths.

The signals produced by photodetectors 144 can then be transmitted to electronic assembly for processing and analysis, and displayed on display 21 as data collected during testing.

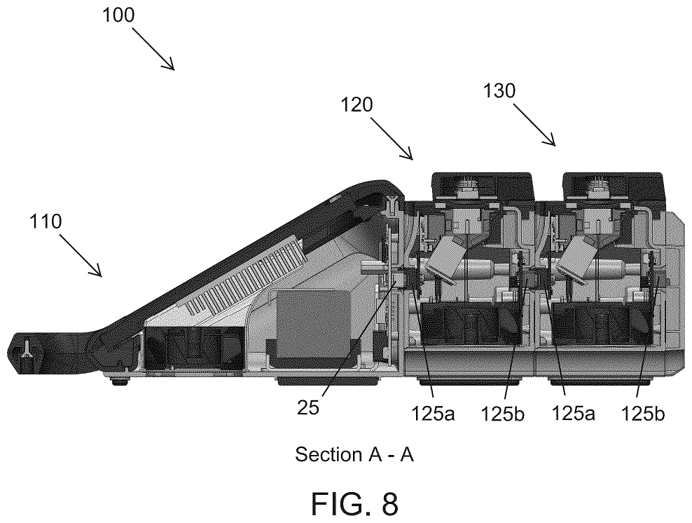

FIG. 8 shows a cross-sectional side view of the assembled testing device 100 along section A-A shown in FIG. 7, which extends through the interfaced electrical connectors 25, 125a between the head unit 110 and first pod unit 120 and electrical connectors 125b. 125a between the first and second pod units. In this manner, identical pod units can be connected either directly to head unit or serially to each other.

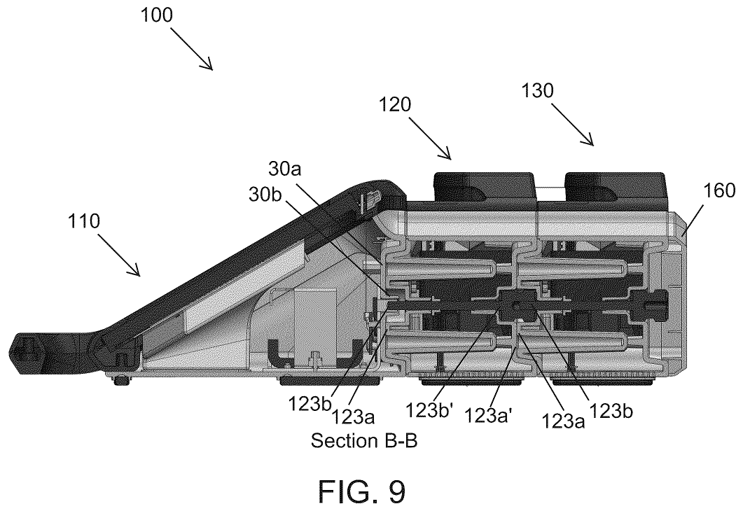

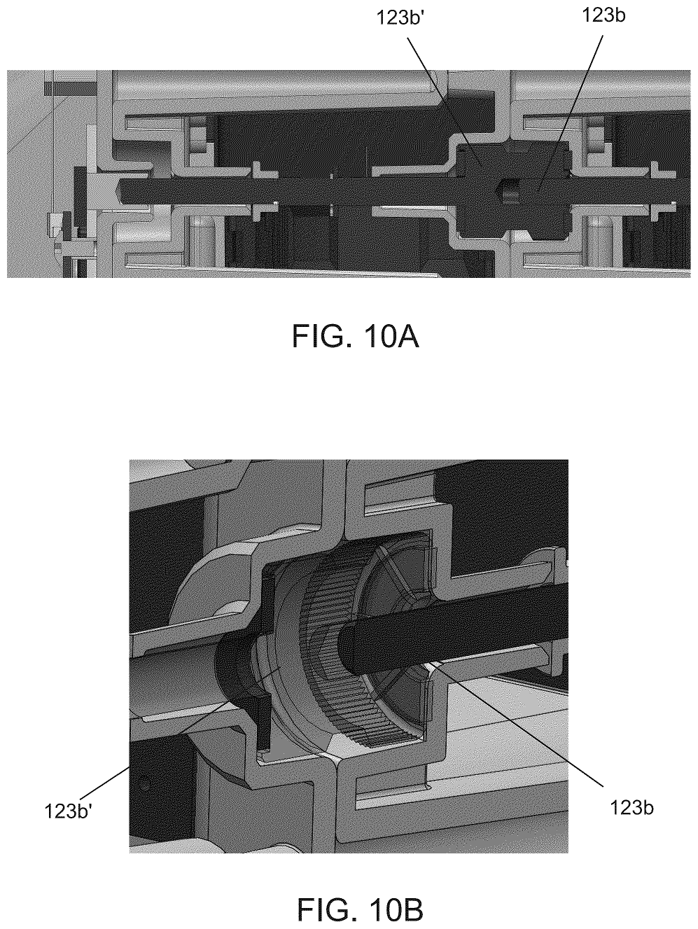

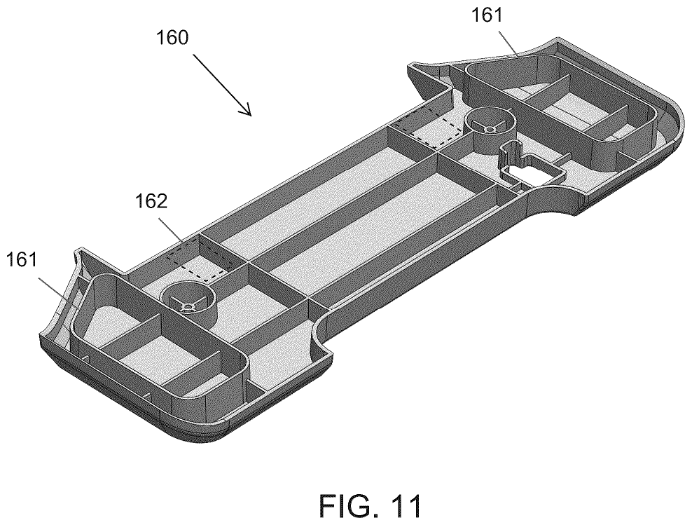

FIG. 9 shows a cross-sectional side view of the assembled testing device 100 along section B-B shown in FIG. 7, which extends through the coupling/lock mechanisms 30, 123 between the head unit 110 and first pod unit 120 and through coupling/lock mechanisms 123, 123′ between the first and second pod units 120, 130. As shown, the raised protruding region 123a of the first pod unit 120 fits into the corresponding recessed portion 30a in the rear side of the head unit, and lock post 123b is received into the lock receptacle 30b in the head unit 110. Similarly, the lock post 123b in the front side of the second pod unit 130 is received within the lock receptacle 123b′ in the rear side of the first pod unit 120, shown in further detail in FIG. 10A. In this embodiment, the coupling mechanism utilizes the rigid stainless battery bracket in the head unit. This bracket contains an integrated nut to which the male threaded end of the pod screw fastens. This male screw has a unique head which includes a female threaded internal receptacle to accept additional screws for sequential pods as well as two recessed rings on both sides of the head which retain rubber gaskets that mate against textured plastic pieces of the head unit and pod body's for securing purposes. The screw has been designed for toolless installation and removal and utilizes a knurled perimeter ring which is tightened by hand. This screw system utilizes traditional thread locking properties as well as friction fit properties. While a particular design has been described here, it is appreciated that variations or other coupling means could be utilized in other embodiments. The rear portion of the last pod unit can be covered by rear cover 160 (shown separately in FIG. 11), which can be attached magnetically or by any suitable means. The rear cover 160 can include one or more coupling features 161, which can include raised or recessed portions that fit into corresponding features of the pod units, or can optionally include one or more magnets 162.

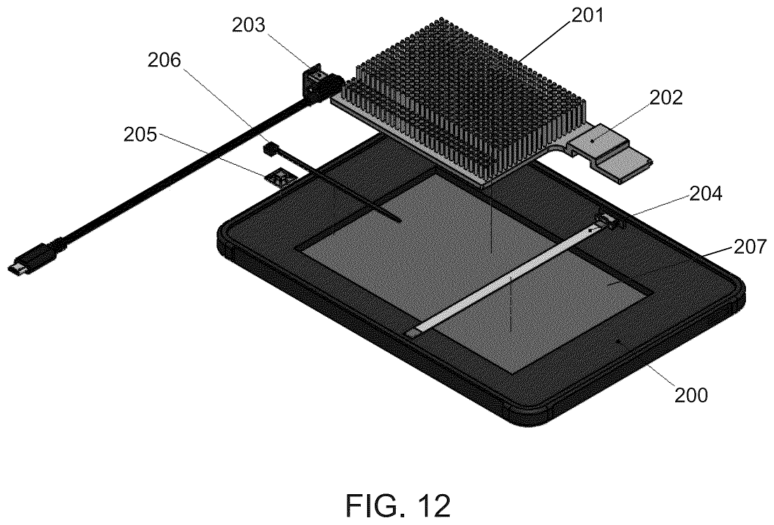

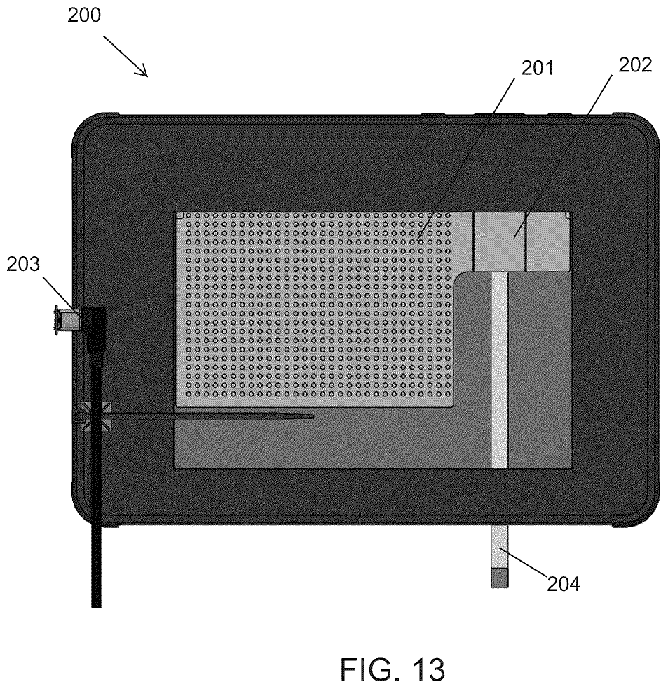

FIGS. 12-13 show an exemplary modified tablet 200, which can be incorporated into the housing of the device for use as the user-interface of the portable testing device 100, as described above. FIG. 12 shows an exploded view and FIG. 13 shows a view of the rear side of the modified tablet assembly. Tablet 200 can utilize a consumer electronics device, such as an off-the shelf tablet computer device with a standard operating system having a touch-screen display and a front-facing camera. In the exemplary embodiment, the tablet has been modified by removal of the battery that allows for mobile operation when used as a mobile device, and in the empty battery area 207 adding a heat sink 201 with power cable retainer 202 has been mounted on the rear side, by strap 204, where the battery has been removed. The heat sink can be attached by a fixture, fasteners, thermally conductive adhesive or any suitable means. The heat sink dissipates heat generated by the modified tablet during operation in the confines of the device housing and the power cable retainer 202 ensures that the flexible power cable 4 that electrically couples the tablet to a power source of the device remains securely attached. The modification can further include attachment of a USB PCB board 205, a cable 203 for peripherals and a zip tie 206 for securing the cable and USC PCB board in place. While a particular configuration is shown, it is appreciated that alternative constructions of the heat sink, cable and methods of attachment could be utilized.

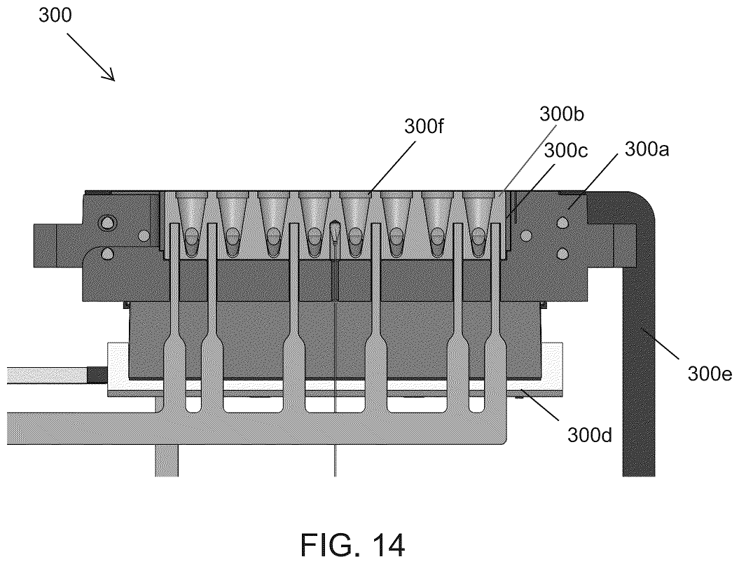

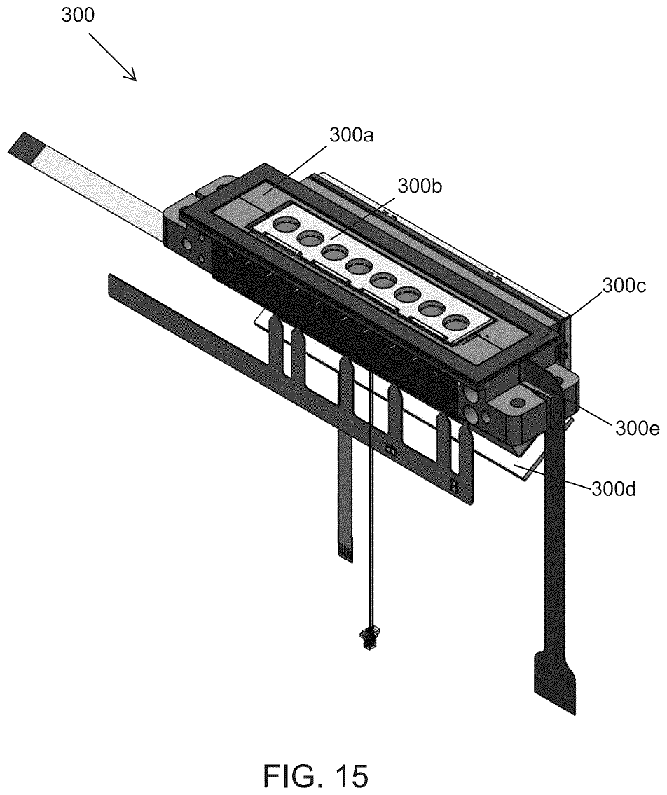

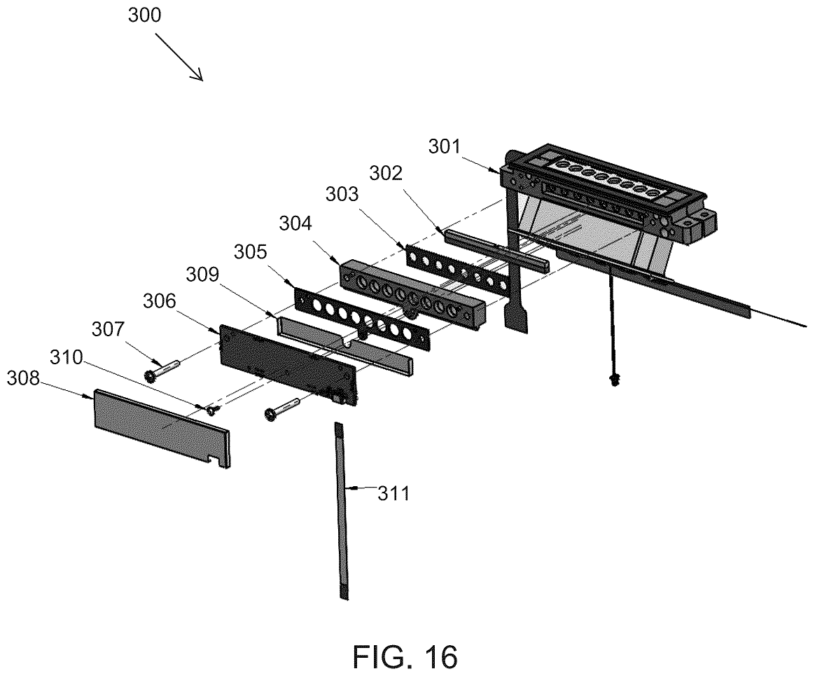

FIGS. 14-16 shows an exemplary well block assembly 300 disposed in each pod unit, in accordance with some embodiments. The well block assembly includes well block housing 300a, an anodized well block 300b, a gasket 300c, and the LED board 300d, a custom focusing lens, and a heater PCB 300e with thermistor. The milled and anodized block 300b includes receptacles 300f for receiving multiple sample tubes (eight sample tubes in this embodiment). The optical assembly LED board 300d includes LED sides with custom PCB, a multiple bandpass emission filter 302, and the ADC board mount 305. In this embodiment, excitation is on the LED side of 300d, and emission is on the ADC side (item 302 in FIG. 16). A sample holder containing a biological sample and reagent mixture, for example tube array 300f, can be placed in receptacle of the well block for testing. The receptacle can be a recess or can be further configured with multiple holes to receive the tube array. In alternate embodiments, receptacle can be configured in any manner that is capable of receiving a sample holder. Additional components of the assembly are depicted in the exploded view of FIG. 16.

FIG. 16 shows an exploded view of the well block assembly 300, which includes the well block 301 a multiple bandpass emission filter 302, mount 303, photodetector block 304, the ADC board mount 305, an ADC board 306, screw fasteners 307, far side electromagnetic (EM) shield 308, sensor side EM shield 309, screw fasteners 310, and a flexible data cable 311 that connects to the ADC board 306. In this embodiment, the PCB design of the ADC board has been updated to continuously takes reads (rather than every few seconds as in conventional designs). Continuous reads are advantageous in that it can be used to collect data showing that a run was tampered with after starting or, in the case of assays that need a mix step at a certain time point, it can show that it was completed or not and at what time. In some embodiments, this step can require user intervention. However, continuous reads can present challenges such as a false spike in results if the lid is opened mid run. Updated software analyzes this continuous read data to detect and distinguish between these differing events.

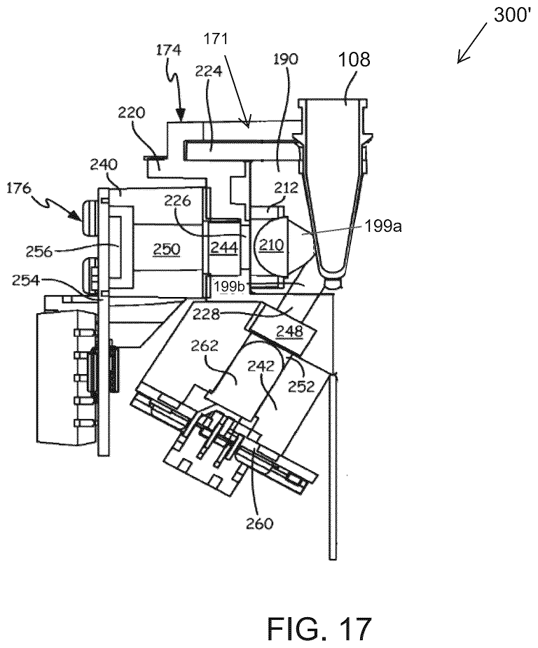

Additional details of an exemplary well block assembly 300′ can be understood by referring to the cross-sectional side view of FIG. 17. When a sample holder is placed in receptacle of the pod unit it will be positioned adjacent the optical assembly 300′ held in pod unit positioned just below the sample tube receptacle. Optical assembly will be able to amplify, excite, and detect the biological sample in the sample holder. Optical assembly includes a heating component that is used to heat the biological sample, causing it to amplify. The heating component can heat the biological sample at a constant temperature or the heating component can cycle the biological sample through different temperatures. Optical assembly will then use radiation to excite the biological sample, so that the biological sample will emit radiation. Emission of radiation occurs if the target analyte is present in the biological sample.

FIG. 17 is a cross-sectional view of another exemplary optical assembly 300″. In this embodiment, a single set of LEDS, photodetectors and filters are provided on one side of the well block. It is appreciated that in other embodiments, another set of LEDs, photodetectors and filters could be provided on the other side of the well block as well. The optical assembly 300′ shown includes cover 171, a lens 210 housing 174, and optical mounting portion 176. Also shown is sample tube 108. Optical assembly is adjacent the well block holding the tube array. Optical assembly 300 includes heating portion 170 to heat the biological sample and reagent mixture in tube 108. Positioned in heating portion 170 is a lens 172 to direct radiation through optical assembly. Housing portion 174 is positioned around heating portion 170 and forms the main body portion of optical assembly 124. Optical mounting portion 176 is positioned on a first side of housing portion 174. The optical mounting portion 176 mounts light-emitting diodes (LEDS) to excite the biological sample and reagent mixture in tube 108 and photodetectors to detect a signal from the biological sample and reagent mixture in tube 108. Heating portion 170 includes sample block 190, heating component 192, temperature sensor 194, wells 196, passages 199a-b. In this embodiment, the light path starts at the LED 262 continues to excitation filter 248 though milled block 210 into sample tube 108 out through milled block 198 through lens 210 through hole in well block housing 226 through emission filter 244 into ADC chips 256.

Heating portion 170) includes sample block 190 that forms the main body portion of heating portion 170. Heating component 192 is attached to a second side of sample block 190. Heating component 192 is a flat polyimide heater in the embodiment shown, but can be any suitable heater in alternate embodiments. Temperature sensor 194 is placed in a bottom portion of sample block 190 to sense the temperature of sample block 190. Further, in alternate embodiments, a thermal cut out switch, such as a PEPI switch, can be placed in series with a lead on heating component 192.

Sample block 190 includes wells 196 on a top side of sample block 190. Each well 196 is sized to receive one tube in tube array 108. In the embodiment shown, heating component 192 heats each of wells 196 at a constant temperature so that modular testing device 100 can be used with isothermal amplification chemistries. In alternate embodiments, heating component 192 can heat each well 196 at a different temperature across a gradient, or there can be a plurality of heating components so that each well is heated by a different heating component to a different temperature. This allows a user to conduct a preliminary test to determine what temperature should be used to analyze a particular biological sample. In further alternate embodiments, heating component 192 can include a thermal cycler that is capable of cycling heating potion 170 through different temperatures so that modular testing device 100 can be used with non-isothermal polymerase chain reaction (PCR) chemistries.

Sample block 190 further includes passages 198, passages 201, passages 202, and passages 204. Passages 198 extend from a first side of sample block 190 to wells 196. Passages 201 extending from a bottom side of sample block 190 to wells 196. Passages 202 extend from the second side of sample block 190 to wells 196. Passages 204 extend from a bottom side of sample block 190 to wells 196. Passages 198, passages 201, passages 202, and passages 204 extend through sample block 190 to direct radiation into and out of the biological sample and reagent mixture in tube array 108 in wells 196.

Lens portion 172 includes lenses 210 that are positioned in sample block 190 of heating portion 170. Passages 198 in sample block 190 are sized to receive lenses 210 on the first side of sample block 190. One lens 210 is positioned in each passage 198 of sample block 190. Lenses 210 are held in passages 198 with lens retainer 212. Lens retainer 212 has a plurality of apertures so that radiation can pass through lens retainer 212 to pass through lenses 210. Housing portion 174 includes first housing 220, heat shield 224, passages 226, passages 228, passages 230, passages 232, and apertures 234. First housing 220 includes passages 226 and passages 228. Passages 226 extend from a first side of first housing 220 to an interior side of first housing 220 adjacent sample block 190. Each passage 226 in first housing 220 is aligned with one passage 198 in sample block 190. Passages 228 extend from a bottom side of first housing 220 to an interior side of first housing 220 adjacent sample block 190. Each passage 228 in first housing 220 is aligned with one passage 200 in sample block 190. Passages 226 and 228 extend through first housing 220 to direct radiation into and out of the biological sample and reagent mixture in tube array 108 in wells 196 of sample block 190.

Heat shield 224 is positioned over sample block 190 and held between first housing 220 and samp. Apertures 234 extend from a top side to a bottom side of heat shield 224. Each aperture 234 in heat shield 224 is aligned with one well 196 in sample block 190. This allows tube array 108 to be positioned in wells 196 in sample block 190 through apertures 234 in heat shield 224. Heat shield 224 is positioned over sample block 190 to prevent heat from escaping out of the top side of sample block 190. Heat shield 224 further provides an insulated surface to protect the user from the top side of sample block 190 when sample block 190 is hot. The optical mounting portion 176 includes housing 240, housing 242, emission filter 244, gasket 246, excitation filter 248, passages 250, passages 252, photodetectors mounting board 254, photodetectors 256, gasket 258, light-emitting diodes mounting board 260, light-emitting diodes 262, and gasket 264. The optical mounting portion 176 is positioned on only one side of housing portion 174. The optical mounting portion 176 includes housing 240 and housing 242 that form a main body portion of first optical mounting portion 176. Housing 240 is attached to a first side of first housing 220 of housing portion 174.

Emission filter 244 is positioned between housing 240 and first housing 220 in a groove on the first side of first housing 220. Gasket 246 is positioned between emission filter 244 and housing 240. Housing 242 is attached to a bottom side of first housing 220 of housing portion 174. Excitation filter 248 is positioned between housing 242 and first housing 220 in a groove on the bottom side of first housing 220. Housing 240 includes passages 250. Passages 250 extend from a first side of housing 240 to an interior side of housing 240 adjacent first housing 220. Each passage 250 in housing 240 is aligned with one passage 226 in first housing 220. Housing 242 includes passages 252. Passages 252 extend from a bottom side of housing 252 to an interior side of housing 242 adjacent first housing 220. Each passage 252 in housing 242 is aligned with one passage 228 in first housing 220.

Photodetectors mounting board 254 is an electronic board that includes photodetectors 256. Each photodetector 256 on photodetectors mounting board 254 is positioned in one passage 250 in housing 240. Gasket 258 is positioned between photodetectors mounting board 254 and housing 240. Light-emitting diodes mounting board 260 is attached to a bottom side of housing 242. Light-emitting diodes mounting board 260 is an electronic board that includes light-emitting diodes 262. Each light-emitting diode 262 on light-emitting diodes mounting board 260) is positioned in one passage 252 in housing 242. Gasket 264 is positioned between light-emitting diodes mounting board 260) and housing 242.

As seen in FIG. 17, optical assembly 300 can excite and detect emissions from a biological sample and reagent mixture in tube 108 that is positioned in the receptacle. Light-emitting diodes 262 are bi-color light-emitting diodes that can emit radiation at two different wavelengths. In the embodiment shown, light-emitting diodes 262 are blue and amber bi-color light-emitting diodes to excite Fluorescein amidite (FAM) fluorescence dye and 6-Carboxyl-X-Rhodamine (ROX) fluorescence dye, respectively. Further, light-emitting diodes 262 emit radiation at a predetermine cycle rate of 1.54 kHz. It is appreciated these wavelengths are exemplary and other wavelengths could be used. While large LEDS are shown here, in some embodiments, the LED board configuration utilizes small surface mount LEDs stacked in a single row. Radiation from light-emitting diodes 262 can pass through passages 252, excitation filter 248, passages 228, and passages 200 into the biological sample and reagent mixture in tube array 108 that is held in wells 196. Excitation filter 248 is a dual bandpass excitation filter that is capable of passing either of the wavelengths emitted by light-emitting diodes 262. Excitation filter 248 is a single filter that extends across the entire length of tube array 108, thus excitation filter 248 extends between adjacent passages 228 in first housing 220. In other embodiments, triple bandpass filters for excitation and emission can be used due to LEDs, light path and filter manufacturing limitations. In some embodiments, the device can utilize two sets of triple bandpass filters for up to six channels. Radiation from light-emitting didoes 262 can excite a fluorescent dye in the biological sample and reagent mixture. This excitation of the fluorescent dye will emit a signal from the biological sample and reagent mixture and the emission can pass through passages 198, passages 226, emission filter 244, and passages 250) to be detected by photodetectors 256. Emission filter 244 is a dual bandpass emission filter in the embodiment shown. Emission filter 244 is a single filter that extends across the entire length of tube array 108, thus emission filter 244 extends between adjacent passages 226 in first housing 220.

Light-emitting diodes are light-emitting diodes that can emit radiation at a single wavelength spectrum. In the embodiment shown, light-emitting diodes 292 are green light-emitting diodes to excite 6-carboxy-X-hexachlorofluorescein (HEX) fluorescence dye. Further, light-emitting diodes 292 emit radiation at a predetermine cycle rate of 1.54 KHz. Radiation from light-emitting diodes 292 can pass through passages 282, excitation filter 278, passages 232, and passages 204 into the biological sample and reagent mixture in tube array 108 that is held in wells 196. Excitation filter 278 is a single bandpass filter that is capable of passing the wavelength emitted by light-emitting diodes 292. Excitation filter 278 is a single filter that extends across the entire length of tube array 108, thus excitation filter 278 extends between adjacent passages 232. Radiation from light-emitting didoes 292 can excite a fluorescent dye in the biological sample and reagent mixture. This excitation of the fluorescent dye will emit a signal from the biological sample and reagent mixture and the emission can pass through passages 202, passages 230, emission filter 274, and passages 280 to be detected by photodetectors 286. Emission filter 274 is a single bandpass filter in the embodiment shown. Emission filter 274 is a single filter that extends across the entire length of tube 108, thus emission filter 274 extends between adjacent passages 230.

In an alternate embodiment, light-emitting diodes 292 can be bi-color light-emitting diodes that can emit radiation at two different wavelengths. Further, excitation filter 278 can be a dual bandpass filter that is capable of passing both of the wavelengths emitted by light-emitting diodes 292, and emission filter 274 can also be a dual bandpass filter. This would result in modular testing device 100 being capable of testing four different fluorescent dyes that can be mixed in with the biological sample and reagents. In some embodiments, the device detects up to six different dyes utilizing two sets of triple bandpass filters.

Light-emitting diodes 262 and light-emitting diodes 292 emit radiation in the form of light that is cycled at a predetermined rate of 1.54 kHz. It is appreciated these wavelengths are exemplary and other wavelengths could be used in other embodiments. This causes emissions from the biological sample and reagent mixture at the same predetermined rate. Photodetectors 256 and photodetectors 286 thus receive the emissions from the biological sample and reagent mixture at a rate of 1.54 kHz as well. The electronic circuitry connected to photodetectors 256 and photodetectors 286 is designed to electronically filter out all other frequencies except for 1.54 kHz. This will negate any ambient light or other radiation sources in modular testing device 100 that may interfere with the accuracy of the testing.

Having a single filter for emission filter 244, excitation filter 248, emission filter 274, and excitation filter 278 and providing the optical assembly on only one side of the receptable simplifies the design of modular testing device 100. This simplified design makes modular testing device 100 more compact and more suitable for use in the field.

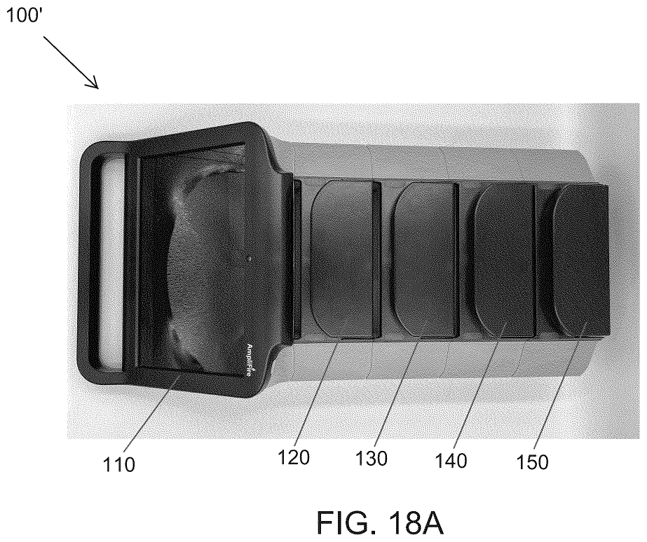

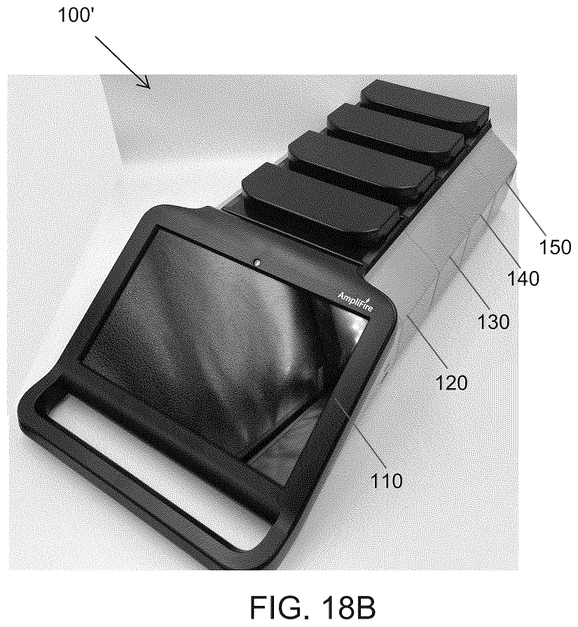

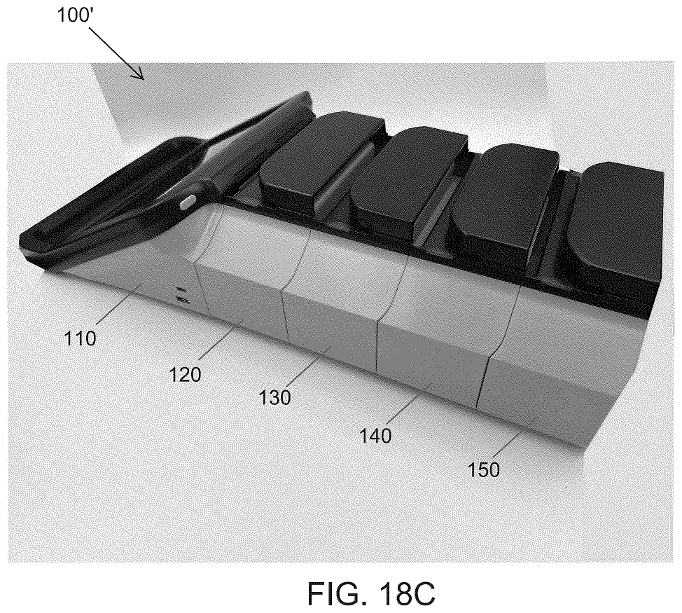

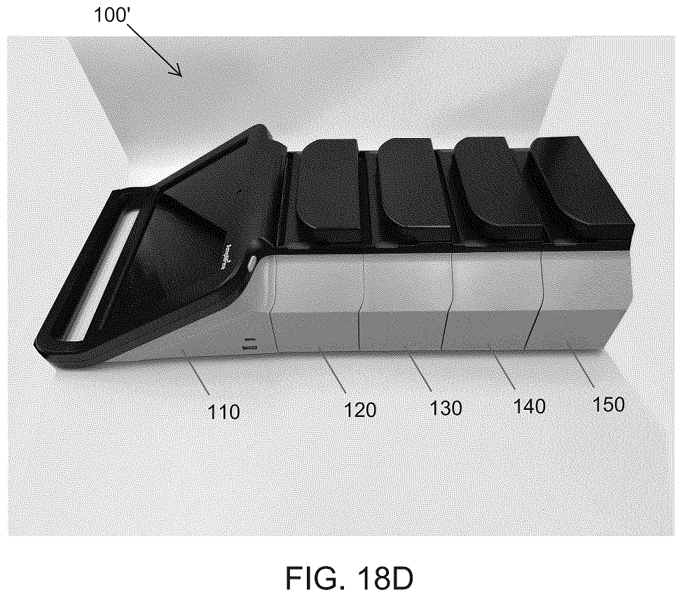

FIGS. 18A-18D shows another configuration of the portable testing device 100′ that includes head unit 110 coupled with four pod units 120, 130, 140, 150 in accordance with some embodiments. FIG. 18A shows an overhead view of the device, FIG. 18B-18C show front and rear perspective views, and FIG. 18D shows a side view. The pod units attach to the head unit and/or adjacent pod units by the same means as that shown in FIGS. 1-8. While four pod units are shown, its appreciated that various other numbers of pod units could be used, for example between three and ten pod units.

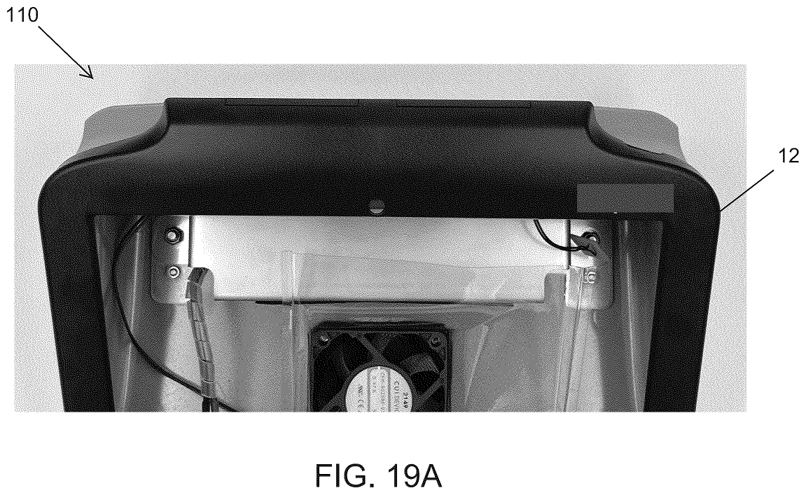

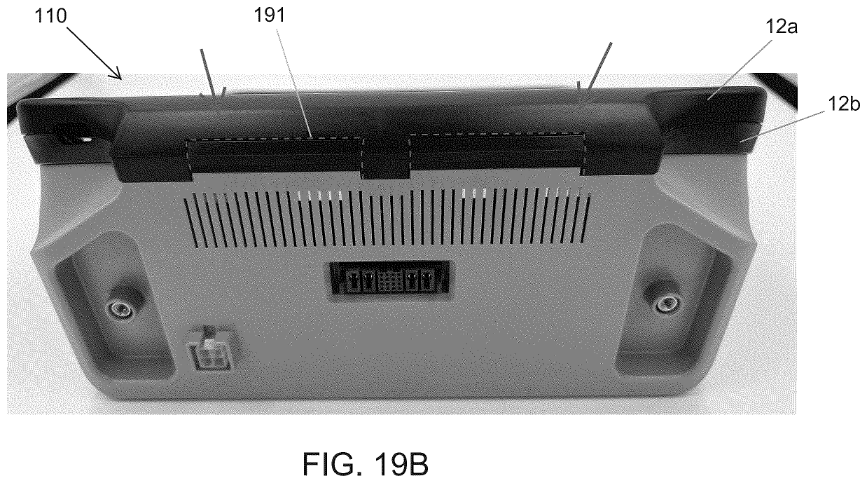

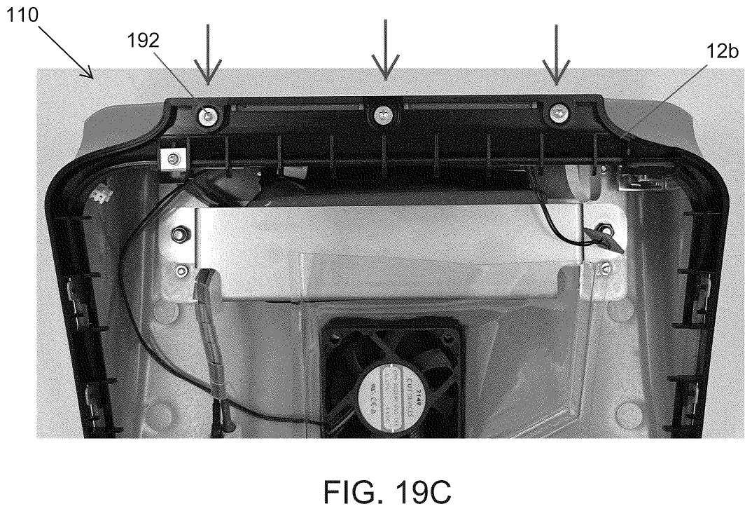

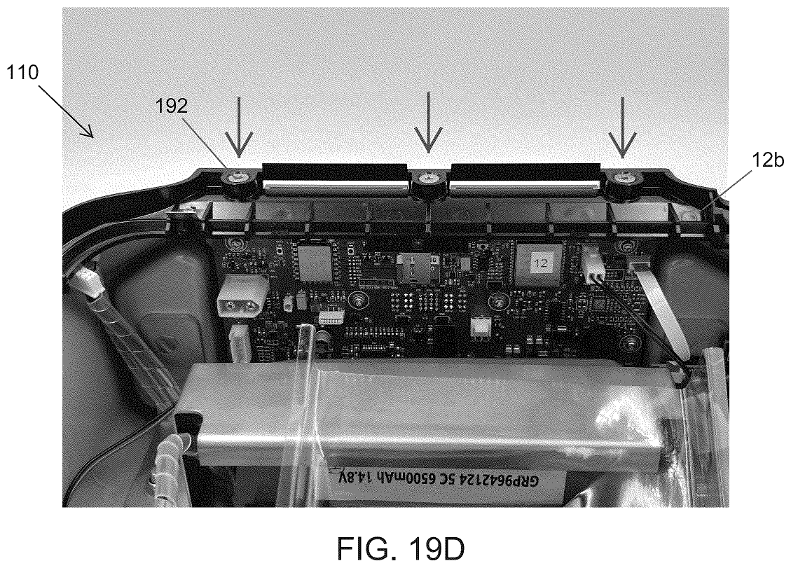

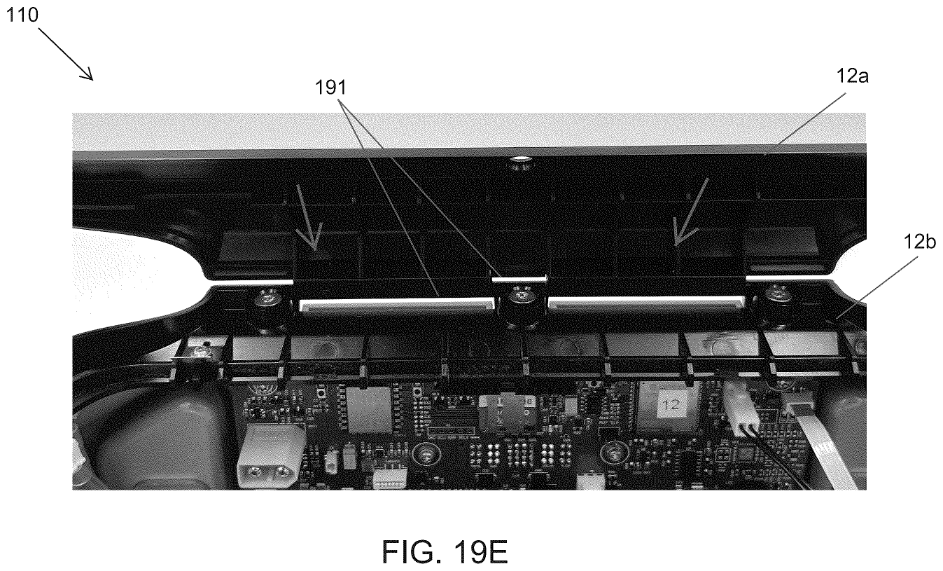

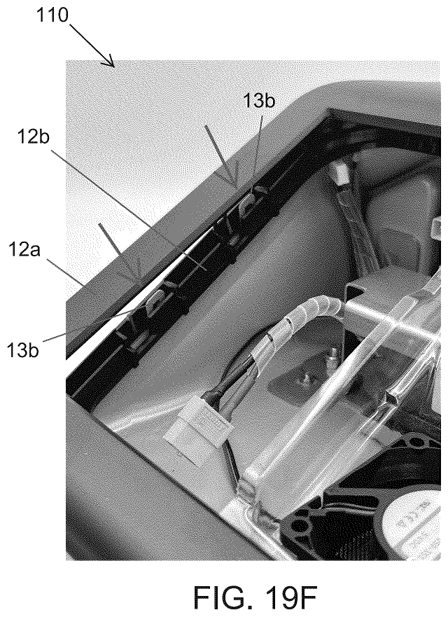

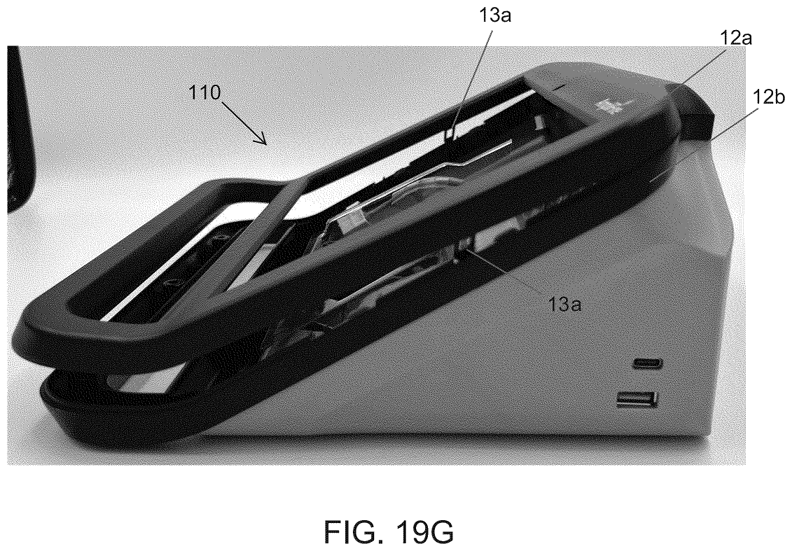

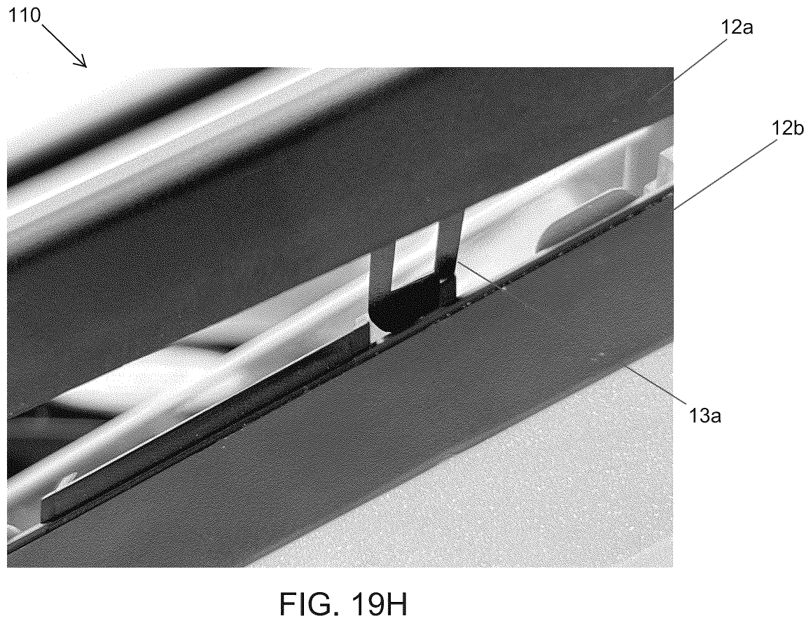

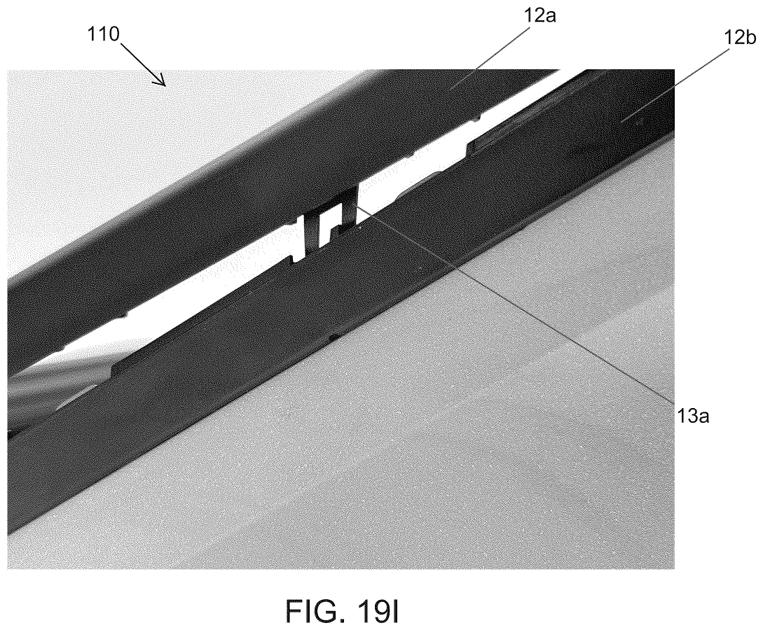

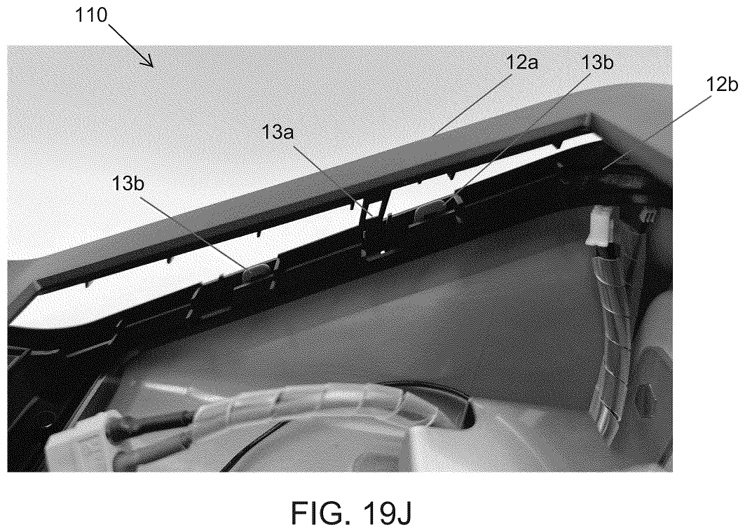

FIGS. 19A-19J show various views of the head unit housing including details of the bezel and tab interface components in accordance with some embodiments. FIG. 19A shows a front view of the upper portion of the head unit 110 on which the bezel 12 is attached in a manner that conceals the means of attachment (e.g. screw) to the main body housing. FIG. 19B shows a rear side of the head unit 110 which shows interlocking tab regions 191 (indicated in dashed line) of the bezel frame 12b and the bezel cover 12a that act as a hinge such that the cover conceals the means of attachment to the main body housing of the head unit. FIG. 19C-D shows a front view of the bezel frame 12b attachment means to the main body housing of the head unit and the interlocking tab region of the bezel frame. In this embodiment, the bezel frame is attached by three screws 192 (see arrows), which are concealed by the bezel cover. FIG. 19E show an inside view of the interlocking tab regions 191 of the bezel frame and cover (see arrows). FIG. 19F show additional tab connections 13b (see arrows) of the bezel frame 12b that engage with the bezel cover along both sides. FIG. 19G-19J shows a side view of the tab connections 13a of the bezel cover 12a that facilitate attachment to the bezel frame 12b.

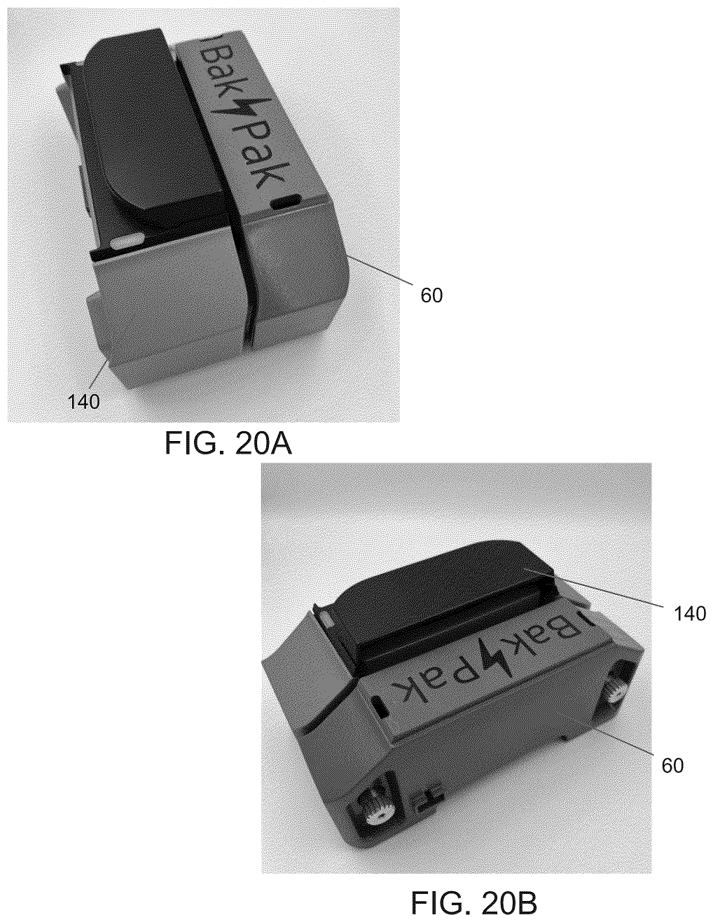

FIGS. 20A-20B shows a battery pack 60 that attaches to a pod unit 140 to allow extended portable use of the device in accordance with some embodiments. The rear cover 160 can attached to the rear side of the battery pack 60. In this embodiment, the battery pack 60 provides substantially more power than that provided by the integrated battery 18 in head unit, to allow the device, especially when coupled with multiple pod units (e.g. 2-10 units), to operate for longer periods of time so as to extend portable use of the device without requiring frequent recharging of the head unit.

While the invention has been described with reference to an exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

What is claimed:

1. A portable testing device comprising:
a head unit having a user interface and a processing unit configured for receiving information from the user interface and transmitting instructions to perform assay testing of one or more biological samples; and
one or more pod units attached and electrically connected to the head unit, wherein each pod unit comprises:
a housing;
a receptacle in which a sample holder containing a biological sample and reagent mixture can be placed; and
an optical assembly positioned in the housing adjacent the receptacle, wherein the optical assembly is configured to amplify and detect a signal from the biological sample and reagent mixture, wherein data that is collected in the optical assembly is communicated to the head unit;
wherein each of the one or more pod units are removably attachable to the head unit and to each other.

2. The portable testing device of claim 1, wherein the one or more pod units comprises 2-10 pod units connected in series.

3. The portable testing device of claim 1, wherein the user interface comprises a touchscreen display of a tablet device that is incorporated within a housing of the head unit.

4. The portable testing device of claim 3, wherein the tablet device is confined between a main body and a bezel of the housing.

5. The portable testing device of claim 4, wherein the bezel is attached to the main body of the housing by a plurality of fasteners that are configured to be non-removable by an end user.

6. The portable testing device of claim 3, wherein the tablet device is modified by removal of a battery thereof.

7. The portable testing device of claim 6, wherein the tablet device is modified by addition of a heat sink on a rear side to dissipate heat generation while operating within the housing of the head unit.

8. The portable testing device of claim 7, wherein the tablet device has been further modified by attaching a power cord retainer and power cord coupling the tablet device to a power source and/or outlet of the portable testing device.

9. The portable testing device of claim 3, wherein the tablet device comprises a specialized application configured for obtaining information as to parameters of assay processing and to control assay processing by the one or more pod units.

10. The portable testing device of claim 1, further comprising:
an optical reader for reading an identifier to obtain information regarding parameters of assay testing to be performed and/or samples to be tested.

11. The portable testing device of claim 10, wherein the identifier is a barcode or QR code.

12. The portable testing device of claim 10, wherein the optical reader is a front-facing camera of a tablet device incorporated into the housing of the head unit.

13. The portable testing device of claim 12, wherein the tablet device is disposed between a bezel and a main body of the housing, and the bezel includes an opening through which the front-facing camera can scan the identifier.

14. The portable testing device of claim 13, wherein the opening includes a magnifying lens to facilitate reading of the identifier.

15. The portable testing device of claim 1, wherein the head unit includes a handle extending from the main body housing to improve portability of the device.

16. The portable testing device of claim 1, wherein each pod unit includes componentry for performing the assay on the biological samples in the receptacle.

17. The portable testing device of claim 16, wherein the head unit is without any receptacle for receiving biological samples.

18. The portable testing device of claim 16, wherein each pod unit comprises a well block assembly that includes a receptacle for receiving the biological samples and an optical assembly adjacent the receptacle configured for thermal cycling and optically exciting and detecting the biological sample to perform assay testing.

19. The portable testing device of claim 18, wherein the optical assembly includes a set of LEDS, multiple bandpass filters, and an ADC board with photodiodes.

20. The portable testing device of claim 18, wherein the optical assembly includes a single set of LEDS, multiple bandpass filters, and a single ADC board with photodiodes that are disposed only on one side of the receptacle.

21. The portable testing device of claim 18, wherein the optical assembly includes a single set of LEDS, multiple bandpass filters, and a single ADC board with photodiodes that are disposed only on one side of the receptacle.

22. The portable testing device of claim 3, wherein the tablet is secured within the housing of the device by a bezel.

23. The portable testing device of claim 22, wherein the bezel comprises a frame and a cover, wherein the frame attached to the main body housing, and the cover attaches to the frame, wherein the frame and cover interface to secure the tablet therebetween.

24. The portable testing device of claim 23, wherein the bezel frame and cover interface by interlocking tab regions.

25. The portable testing device of claim 24, wherein the bezel frame and cover further interface by tab connections.
